(19) United States
(12) Patent Application Publication
(10) Pub. No.: US 2020/0267353 A1
(43) Pub. Date: Aug. 20, 2020

(54) DISPLAY PROCESSING DEVICE

(71) Applicant: DENSO CORPORATION, Kariya-city (JP)

(72) Inventors: Hiroshi ISHIDA, Kariya-city (JP); Hirohiko YANAGAWA, Kariya-city (JP); Shusaku SHIGEMURA, Kariya-city (JP)

(21) Appl. No.: 16/869,966

(22) Filed: May 8, 2020

Related U.S. Application Data
(63) Continuation of application No. PCT/JP2018/041347, filed on Nov. 7, 2018.

(30) Foreign Application Priority Data
Nov. 10, 2017 (JP) 2017-217359

(51) Int. Cl. H04N 7/18; H04N 5/272; H04N 5/225; H04N 5/247; B60R 1/00

(52) U.S. Cl. CPC H04N 7/181; H04N 5/272; H04N 5/2253; H04N 5/247; B60R 2300/304; B60R 2300/20; B60R 2300/105; B60R 2300/607; B60R 2300/303; B60R 1/00

(57) ABSTRACT

In a display processing device, an acquisition section acquires a captured image of surroundings of the vehicle from at least one imaging device installed in a vehicle. A first generation section generates a first converted image that is an image as seen from a first viewpoint in the vehicle, based on the captured image at a latest imaging time point. A calculation section calculates displacement of the vehicle. A second generation section generates a second converted image that is an image as seen from the first viewpoint at the latest imaging time point and is an image of an area including under the vehicle, based on the captured image captured earlier than the latest imaging time point and the displacement. The display processing section causes a display device visible to an occupant of the vehicle to display a display image obtained by compositing the first and second converted images.

### CROSS-REFERENCE TO RELATED APPLICATION

The present application is based on and claims the benefit of priority from Japanese Patent Application No. 2017-217359 filed on Nov. 10, 2017 with the Japan Patent Office, the entire description of which is incorporated herein by reference.

### BACKGROUND

### Technical Field

The present disclosure relates to a display processing device installed in a vehicle.

### Related Art

An image generation device is disclosed in which a single part seen from two different virtual viewpoints is displayed in the centers of two images so that the driver of a vehicle can correctly comprehend the situation of the place to be checked.

### SUMMARY

An aspect of the present disclosure is a display processing device installed in a vehicle. The device includes: an acquisition section configured to acquire a captured image of surroundings of the vehicle from at least one imaging device installed in the vehicle; a first generation section configured to generate a first converted image that is an image as seen from a first viewpoint in an interior of the vehicle, based on the captured image at a latest imaging time point; a calculation section configured to calculate displacement of the vehicle; a second generation section configured to generate a second converted image that is an image as seen from the first viewpoint at the latest imaging time point and is an image of an area including under the vehicle, based on the captured image captured earlier than the latest imaging time point and the displacement; and a display processing section configured to cause a display device visible to an occupant of the vehicle to display a display image obtained by compositing the first converted image and the second converted image.

### BRIEF DESCRIPTION OF THE DRAWINGS

In the accompanying drawings:

FIG. 1 is a block diagram showing a configuration of a display processing device;

FIG. 2 is a diagram showing installed positions of cameras;

FIG. 3 is a flowchart of an image display process;

FIG. 4 is a flowchart of a first image conversion process;

FIG. 5 is a flowchart of a second image conversion process;

FIG. 6 is a flowchart of an image history composition process;

FIG. 7 is a diagram showing a generation method of a history composite image using two cameras;

FIG. 8 is a diagram showing a display image; and

FIG. 9 is a diagram showing a generation method of a history composite image using one camera.

### DETAILED DESCRIPTION OF THE PREFERRED EMBODIMENTS

Japanese Patent No. 5977130 discloses an image generation device in which a single part seen from two different virtual viewpoints is displayed in the centers of two images so that the driver of a vehicle can correctly comprehend the situation of the place to be checked. In this image generation device, a composite image IMa and a composite image IMb are displayed as display images on a display. The composite image IMa is an image generated on the basis of a virtual viewpoint VPa that is located at a viewpoint position near the viewpoint position of the driver of the vehicle and has a line-of-sight direction in a predetermined direction from the viewpoint position. The composite image IMb is an image generated based on a virtual viewpoint VPb that is located at a viewpoint position outside the vehicle and has a line-of-sight direction in a direction indicating a specific place located on the extension of the line-of-sight direction of the virtual viewpoint VPa.

However, an in-vehicle camera is arranged in a vehicle body so as to face outward, and thus cannot capture an image of an area under the vehicle. Therefore, the images of surroundings of an own vehicle captured by the in-vehicle camera do not include images of the area under the vehicle. Accordingly, as a result of detailed examination, the inventor has found that no image of the area under the vehicle is displayed as the display image generated by the image generation device described above, which makes it difficult to comprehend the situation under the vehicle.

An aspect of the present disclosure is to provide a display processing device that can generate a display image to allow comprehension of the situation under the vehicle.

Hereinafter, an exemplified embodiment of the present disclosure will be described with reference to the drawings.

### 1. CONFIGURATION

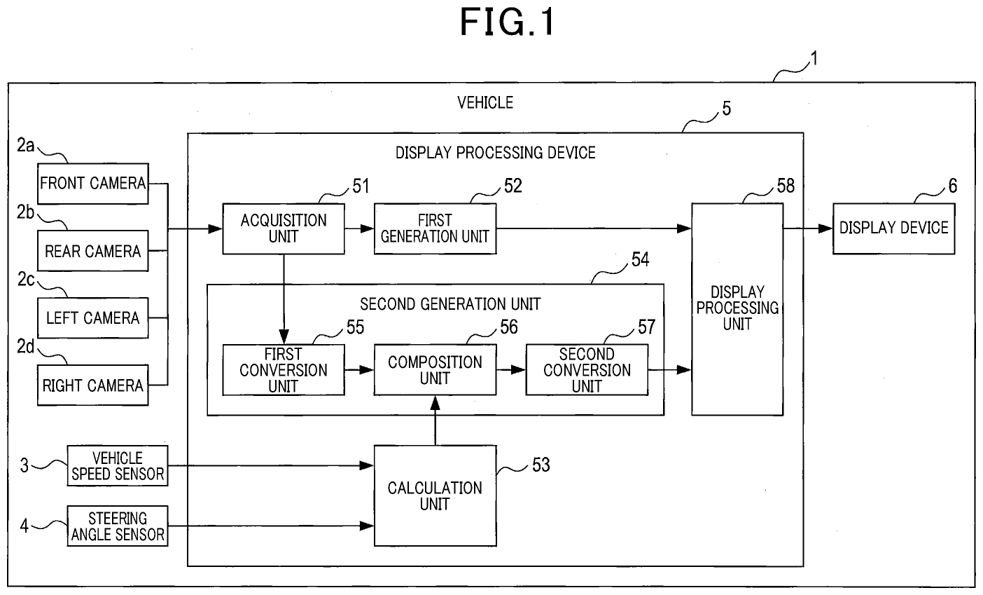

A vehicle 1 shown in FIG. 1 includes a front camera 2a, a rear camera 2b, a left camera 2c, a right camera 2d, a vehicle speed sensor 3, a steering angle sensor 4, a display processing device 5, and a display device 6.

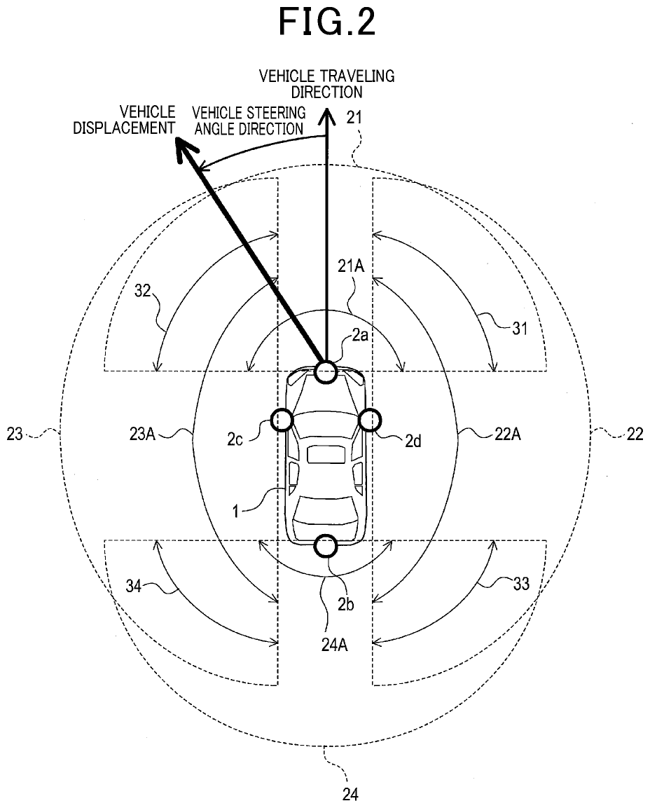

The cameras 2a to 2d are imaging devices that capture images of surroundings of the vehicle 1 and output signals representing the captured images to the display processing device 5 via LVDS communication line or the like. The front camera 2a, the rear camera 2b, the left camera 2c, and the right camera 2d are respectively arranged to capture images of areas on the front, rear, left, and right sides of the vehicle 1 as shown in FIG. 2.

As shown in FIG. 2, the front camera 2a captures an image of the area on the front side in the surroundings of the vehicle 1. A displayable range 21A of a captured front image 21 is almost 180 degrees with the use of a fisheye lens or the like, for example.

The right camera 2d captures an image of the area on the right side in the surroundings of the vehicle 1. A displayable range 22A of a captured right image 22 is almost 180 degrees with the use of a fisheye lens or the like, for example. A part of the displayable range 21A and a part of the displayable range 22A overlap. The overlap range will be referred to as an overlap range 31. The overlap range 31 is 90 degrees, for example.

The left camera 2c captures an image of the area on the left side in the surroundings of the vehicle 1. A displayable range 23A of a captured left image 23 is almost 180 degrees with the use of a fisheye lens or the like, for example. A part of the displayable range 23A and a part of the displayable range 21A overlap. This overlap range will be referred to as an overlap range 32. The overlap range 32 is 90 degrees, for example.

The rear camera 2b captures an image of the area on the rear side in the surrounding of the vehicle 1. A displayable range 24A of a captured rear image 24 is almost 180 degrees with the use of a fisheye lens or the like, for example. A part of the displayable range 24A and a part of the displayable range 22A overlap. This overlap range will be referred to as an overlap range 33. The overlap range 33 is 90 degrees, for example.

A part of the displayable range 24A and a part of the displayable range 23A overlap. The overlap range will be referred to as an overlap range 34. The overlap range 34 is 90 degrees, for example.

The vehicle speed sensor 3 is a sensor for detecting the running velocity of the vehicle 1. The vehicle velocity sensor 3 outputs a signal corresponding to the running speed to the display processing device 5 via an in-vehicle communication LAN such as CAN. The term CAN is a registered trademark.

The steering angle sensor 4 is a sensor for detecting the steering angle of the vehicle 1. The steering angle sensor 4 outputs a signal corresponding to the detected steering angle to the display processing device 5 via an in-vehicle communication LAN such as CAN.

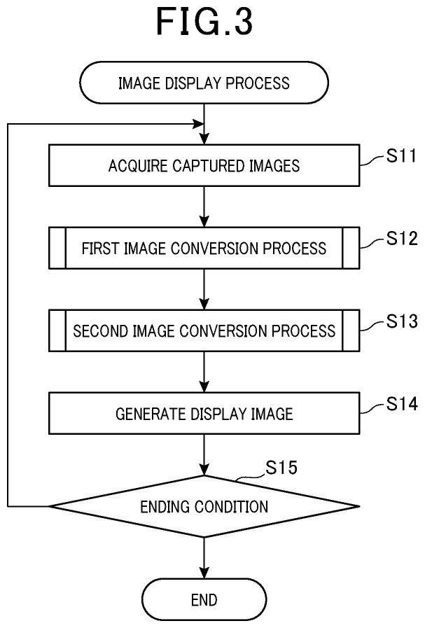

The display processing device 5 is configured mainly of a known microcomputer having a CPU, ROM, RAM, flash memory, and others not shown. The CPU executes programs stored in the ROM as a non-transitory tangible recording medium. When any of the programs is executed, a method corresponding to the program is performed. Specifically, the display processing device 5 executes an image display process shown in FIG. 3 described later in accordance with the program. The display processing device 5 may include one or more microcomputers.

The display processing device 5 includes an acquisition section 51, a first generation section 52, a calculation section 53, a second generation section 54, a first conversion section 55, a composition section 56, a second conversion section 57, and a display processing section 58 as a functional configuration implemented by the CPU executing the programs. The method for implementing the functions of the sections included in the display processing device 5 is not limited to software but some or all of the functions may be implemented by using one or more hardware units. For example, when the functions are implemented by an electronic circuit as hardware, the electronic circuit may be implemented by a digital circuit, an analog circuit, or a combination of them.

The display device 6 is a display for displaying images that is provided at a position where the driver of the vehicle 1 can view the display, and that is connected to the display processing device 5 via an LVDS communication line or the like.

### 2. PROCESS

Next, an image display process executed by the display processing device 5 will be described with reference to the flowchart in FIG. 3. The image display process is executed by, for example, an ON operation using an ignition switch, a display command operation or an unlock operation by the user, or the like.

In S11, the display processing device 5 acquires respective captured images from the cameras 2a to 2d. The step S11 corresponds to processing by the acquisition section 51.

In S12, the display processing device 5 executes a first image conversion process.

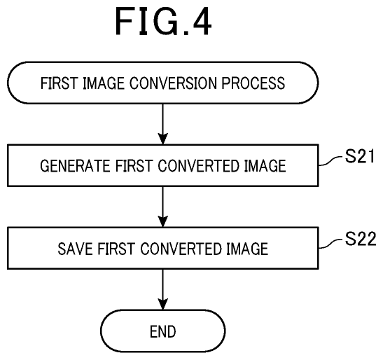

The detailed contents of the first image conversion process will be described with reference to the flowchart shown in FIG. 4.

In S21, the display processing device 5 generates a first converted image obtained by converting the captured images acquired in S11 into an image seen from a first viewpoint. The first viewpoint refers to a virtual viewpoint in the interior of the vehicle 1, and the image seen from the first viewpoint refers to a perspective image of the outside of the vehicle seen from the interior of the vehicle. Since the cameras 2a to 2d are arranged in the vehicle 1 so as to be faced outside of the vehicle body, the captured images include no images close to the vehicle and no images under the vehicle. Therefore, the image seen from the first viewpoint is an image of surroundings of the vehicle 1 not including the area under the vehicle.

Specifically, the four captured images of the areas on the front, rear, left, and right sides of the vehicle 1 acquired in S11 are composited by adjusting the transmission ratios of the parts of the captured images with the overlap imaging ranges of the cameras 2a to 2d or by using predetermined boundary lines. That is, the images captured by the cameras 2a to 2d have predetermined correspondences with the positions of pixels included in the captured images and are composited by being projected onto a virtual three-dimensional curved surface arranged in the surroundings of the vehicle 1. A necessary area in the three-dimensional curved surface is extracted as an image in accordance with a line-of-sight direction from the preset virtual viewpoint. Accordingly, the first converted image seen from the first viewpoint is generated. The first converted image here is to be used as a display image immediately after the conversion, and thus has almost the same display contents as those of the images at the time of image capturing and is a substantially real-time image.

In S22, the display processing device 5 saves the first converted image in a flash memory and terminates the first image conversion process, and then the process proceeds to S13. The steps S21 and S22 correspond to processing by the first generation section 52.

Returning to FIG. 3, in S13, the display processing device 5 executes a second image conversion process.

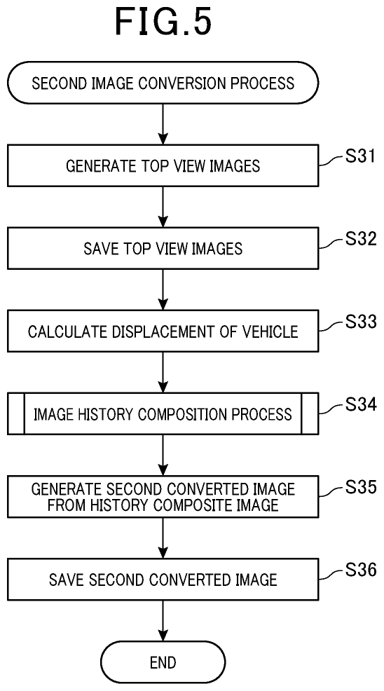

The detailed contents of the second image conversion process will be described with reference to the flowchart shown in FIG. 5.

In S31, the display processing device 5 generates a top view image by converting the images captured by the cameras 2a to 2d in S11 into an image as seen from a second viewpoint. The second viewpoint refers to a viewpoint outside of the vehicle 1 that is seen downward from above the vehicle 1 as a top view. The step S31 corresponds to processing by the first conversion section 55.

In S32, the display processing device 5 saves the top view image in the flash memory.

In S33, the display processing device 5 calculates the displacement of the vehicle 1 represented by a moving distance and a rotation angle based on the information of the running speed and steering angle acquired from the vehicle speed sensor 3 and the steering angle sensor 4. The step S33 corresponds to processing by the calculation section 53.

In S34, the display processing device 5 executes an image history composition process.

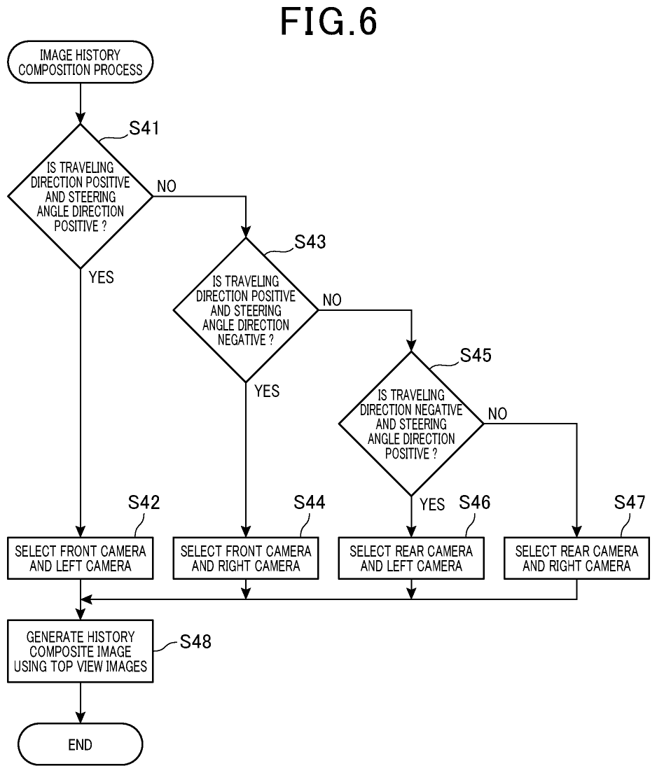

The detailed contents of the image history composition process will be described with reference to the flowchart shown in FIG. 6.

In S41, the display processing device 5 determines whether the traveling direction of the vehicle 1 is positive and the steering angle direction is positive. The traveling direction of the vehicle 1 is positive when the vehicle 1 is traveling forward. On the other hand, the traveling direction of the vehicle 1 is negative when the vehicle 1 is traveling rearward. The steering angle direction of the vehicle 1 is positive when the vehicle 1 is turning leftward. The steering angle direction of the vehicle 1 is negative when the vehicle 1 is turning rightward. The steering angle direction is also positive in the state where the vehicle 1 is moving forward or rearward without turning.

When determining in S41 that the traveling direction of the vehicle 1 is positive and the steering angle direction of the vehicle 1 is positive, the display processing device 5 moves the process to S42 to select the front camera 2a and the left camera 2c, and then the process proceeds to S48.

On the other hand, when not determining in S41 that the traveling direction of the vehicle 1 is positive and the steering angle direction of the vehicle 1 is positive, the display processing device 5 moves the process to S43 to determine whether the traveling direction of the vehicle 1 is positive and the steering angle direction of the vehicle 1 is negative.

When determining in S43 that the traveling direction of the vehicle 1 is positive and the steering angle direction of the vehicle 1 is negative, the display processing device 5 moves the process to S44 to select the front camera 2a and the right camera 2d, and then the process proceeds to S48.

On the other hand, when not determining in S43 that the traveling direction of the vehicle 1 is positive and the steering angle direction of the vehicle 1 is negative, the display processing device 5 moves the process to S45 to determine whether the traveling direction of the vehicle 1 is negative and the steering angle direction of the vehicle 1 is positive.

When determining in S45 that the traveling direction of the vehicle 1 is negative and the steering angle direction of the vehicle 1 is positive, the display processing device 5 moves the process to S46 to select the rear camera 2b and the left camera 2c, and then the process proceeds to S48.

On the other hand, when not determining in S45 that the traveling direction of the vehicle 1 is negative and the steering angle direction of the vehicle 1 is positive, that is, when determining that the traveling direction of the vehicle 1 is negative and the steering angle direction of the vehicle 1 is negative, the display processing device 5 moves the process to S47 to select the rear camera 2b and the right camera 2d, and then the process proceeds to S48.

In S48, the display processing device 5 composites a plurality of top view images different in imaging time point with positional shifts based on the displacements between the different imaging time points to generate a history composite image that is an image seen from the second viewpoint as the latest imaging viewpoint. The history composite image is an image that can include the area under the vehicle seen from the second viewpoint at the latest imaging time point. The step S48 corresponds to processing by the composition section 56. The history composition here refers to complementing a part of a top view image at a time point t that has passed outside the imaging range due to movement, by the use of the top view image at a time point t−1. For example, JP 2002-373327 A and JP 2003-191810 A describe history composite techniques for complementing an area outside the imaging range by a past image.

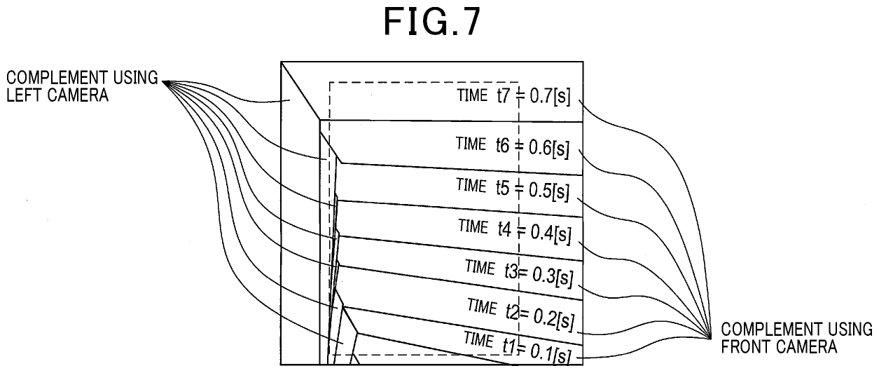

As an example, description will be given as to a case in which the traveling direction of the vehicle 1 is positive and the steering angle direction of the vehicle 1 is positive and the front camera 2a and the left camera 2c are selected as shown in FIG. 7. Based on the displacement of the vehicle 1 calculated in S33, the position of a first top view image as the top view image at a time t1 captured by the front camera 2a and saved in the flash memory is shifted to generate a post-movement top view image that is a top view image after the movement. Then, a second top view image that is the top view image newly captured at a time t2 and saved in the flash memory and the post-movement top view image are composited to generate a history composite image. That is, the history composite image is generated such that a part having passed outside the field of view of the front camera 2a due to this movement of the vehicle 1, that is, a part of the post-movement top view image is written outside a new field of view of the front camera 2a corresponding to the second top view image. In the present embodiment, the history composite image is generated every 0.1 second. The selected left camera 2c is used to complement the region in the history composite image outside the field of view that cannot be filled by the use of the front camera 2a.

The display processing device 5 generates the history composite image in S48, terminates the image history composition process, and moves the process to S35. In the present embodiment, the camera images to be used from the displacement direction of the vehicle are selected, and the top-view history composite image is generated using only the selected camera images. Alternatively, the images of all four cameras may be used to generate the top-view history composite image.

Returning to FIG. 5, in S35, the display processing device 5 generates a second converted image of the history composite image seen from the first viewpoint. The second converted image is an image that can include the area under the vehicle as seen from the first viewpoint. The step S35 corresponds to processing by the second conversion section 57 and the steps S31, S35, and S48 correspond to processing by the second generation section 54.

In S36, the display processing device 5 saves the second converted image in the flash memory, terminates the second image conversion process, and then the process proceeds to S14. The steps S12 and S13 may be serial steps or parallel steps.

Returning to FIG. 3, in S14, a blind region of a camera corresponding to the area under the vehicle is specified in the first converted image generated in S12 and an image area corresponding to the specified area in the second converted image generated in S13 is composited with the first converted image to generate a display image. During the composition of the specified area of the second converted image with the first converted image, the display processing device 5 lowers the brightness of the second converted image saved in the flash memory to generate the display image. Then, the display processing device 5 causes the display device 6 to display the display image on which a semi-transmissive image of the vehicle 1 stored in advance in the flash memory is superimposed. The brightness of the second converted image is lowered for the purpose of making the first converted image and the second converted image identifiable in the display image.

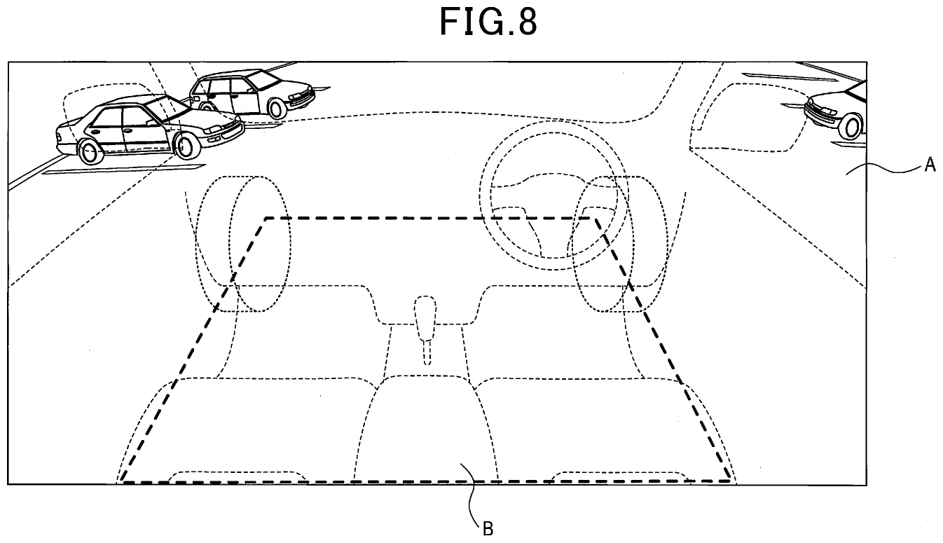

As shown in FIG. 8, the region of the display image in which the first converted image is displayed will be designated as region A and the region of the display image that is not filled with the first converted image, that is, the region of the display image in which the second converted image is displayed will be designated as region B. In FIG. 8, the boundary is shown between the region A and the region B by a broken line not seen in the display image, and the region A is located outside the broken line and the region B is located inside the broken line. The region B indicates the area under the vehicle.

In S14, when the second converted image filling the entire region B is not saved in the flash memory, the display processing device 5 causes the display device 6 to display a display image with which a predetermined background image, for example, a solid-black image is composited instead of the second converted image until the second converted image filling the entire region B is generated. When the second converted image filling at least part of the region B is saved in the flash memory, the display processing device 5 may cause the display device 6 to display a display image generated by compositing the second converted image instead of at least part of the background image, that is, by writing the second converted image over the background image. The step S14 corresponds to processing by the display processing section 58.

In S15, the display processing device 5 determines whether an image display process end condition is satisfied. Specifically, the display processing device 5 determines whether an operation for turning off the ignition switch or an operation for another display has been performed. When not determining that the end condition is satisfied, that is, when not determining an operation for turning off the ignition switch or an operation for another display has been performed, the display processing device 5 returns the process to S11.

On the other hand, when determining in S15 that the end condition is satisfied, that is, an operation for turning off the ignition switch or an operation for another display has been performed, the display processing device 5 terminates the image display process. Even when an operation for turning off the ignition switch has been performed, the display processing device 5 may continue the display until a predetermined time elapses or a locking operation is performed to allow the comprehension of the surrounding situation before the termination of the display process.

### 3. ADVANTAGEOUS EFFECTS

According to the embodiment described above in detail, the following advantageous effects can be obtained.

(3a) In the present embodiment, the first generation section 52 generates the first converted image that is an image seen from the first viewpoint in the interior of the vehicle 1 based on the captured images at the latest imaging time point. In addition, the second generation section generates the second converted image that is an image seen from the first viewpoint at the latest imaging time point and can include the area under the vehicle based on the images captured earlier than the latest imaging time point and the displacement of the vehicle 1. Then, the display processing section displays the display image obtained by compositing the first converted image and the second converted image on the display device 6.

According to this configuration, the first converted image that is an image of surroundings of the vehicle 1 seen from the first viewpoint and not including the area under the vehicle and the second converted image that can include the area under the vehicle are composited. This makes it possible to generate the display image as an image of surroundings of the vehicle 1 that is seen from the first viewpoint and can include the area under the vehicle. Therefore, the driver can comprehend the situation under the vehicle.

(3b) In the present embodiment, the captured images of surroundings of the vehicle 1 are converted into the top view images seen from the second viewpoint. Then, the history composite image is generated by compositing the plurality of top view images different in imaging time point with positional shifts based on the displacement of the vehicle 1 between the different imaging time points.

According to this configuration, the image of the area under the vehicle not affected by the perspectives of the captured images is used to generate the history composite image. Therefore, it is possible to display the image of the area under the vehicle with less feeling of strangeness in the region B of the display image.

(3c) In the present embodiment, the display image with which the background image is composited instead of the second converted image is displayed on the display device 6 until the second converted image filling the entire region B is generated. According to this configuration, it is possible to prevent the display of an incomplete image of the area under the vehicle.

(3d) In the present embodiment, the display image is displayed on the display device 6 so that the first converted image and the second converted image are identifiable. According to this configuration, it is possible to, in the display image, clarify the boundary between the region A where the captured images at the latest imaging time point are displayed and the region B where an image different from the captured images at the latest imaging time point is displayed. In the identifiable mode, the brightness of the second converted image is lowered to make darker the region B where the image of the area under the vehicle is displayed than the region A where the images of surroundings of the vehicle 1 are displayed. Therefore, the driver can easily recognize by instinct the image of the area under the vehicle.

(3e) In the present embodiment, in the image history composition process, two cameras to be used in image composition are selected based on the displacement of the vehicle 1. The region in the history composite image outside the field of view that cannot be filled by one camera is complemented by the use of the second camera. According to this configuration, it is possible to make it unlikely that there will be regions outside the field of view while reducing the process load as compared with the case of using four cameras.

### 4. OTHER EMBODIMENTS

An embodiment of the present disclosure has been described so far. However, it is to be noted that the present disclosure is not limited to the foregoing embodiment but can be carried out in various modes.

(4a) In the foregoing embodiment, the vehicle 1 includes four cameras, that is, the front camera 2a, the rear camera 2b, the left camera 2c, and the right camera 2d as an example. Alternatively, the vehicle 1 may include one or two cameras, for example.

(4b) In the foregoing embodiment, the display processing device 5 lowers the brightness of the second converted image so that the first converted image and the second converted image are identifiable in the display image, but the identification method is not limited to this. For example, the brightness of the second converted image in the region B may be adjusted by changing the color of a part of the image of the vehicle body of the vehicle 1 that is superimposed in a semi-transmissive manner on the display image and overlaps the region B. In addition, for example, a frame surrounding the region B may be displayed in the broken-line part of the display image shown in FIG. 8.

(4c) When a moving body is included in the region B where an image different from the captured images at the latest imaging time point is displayed, the display processing device 5 may blot pixels also in the vicinity of the moving body because the presence of the moving body is of low reliability.

(4d) When a non-contact charger is included in the region B, the display processing device 5 may superimpose a specific mark on the display image.

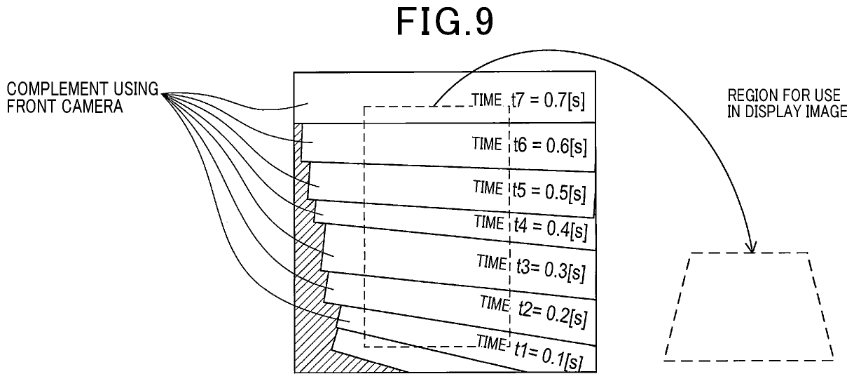

(4e) In the foregoing embodiment, two cameras are used to generate the history composite image. Alternatively, one camera may be used to generate the history composite image, for example. As shown in FIG. 9, for example, when only the front camera 2a is used to generate the history composite image, the region in the history composite image outside the field of view that cannot be filled with the use of the front camera 2a is not complemented. However, the use of a region narrower than the history composite image for the display image eliminates the need for complementing the region outside the field of view.

(4f) In the foregoing embodiment, a black image is displayed as the background image as an example. However, the background image is not limited to this. For example, when image display is started by an operation for turning on the ignition switch or an operation instructing start of display, the second converted image saved in the previous image display process such as at the time of an operation for turning off the ignition switch or at the time of an operation for another display may be displayed. In that case, the display may be provided in a mode in which the freshness of the complementary image can be known by color, contrast, brightness, icon superimposition, or the like.

(4g) Functions possessed by one constituent element in the foregoing embodiment may be dispersed among a plurality of constituent elements, or functions possessed by a plurality of constituent elements may be integrated into one constituent element. Some of the components of the foregoing embodiment may be omitted. At least some of the components of the foregoing embodiment may be added to or replaced with others of the constituent elements of the foregoing embodiment. All the modes included in the technical ideas specified by the description of the claims are embodiments of the present disclosure.

(4h) The present disclosure can be implemented by, besides the display processing device 5 described above, various forms such as a system having the display processing device 5 as a constituent element, a program for causing the display processing device 5 to function as a computer, a medium recording this program, an image generation method, and others.

An aspect of the present disclosure is a display processing device (5) installed in a vehicle (1), which includes: an acquisition section (51); a first generation section (52); a calculation section (53); a second generation section (54); and a display processing section (58). The acquisition section is configured to acquire a captured image of surroundings of the vehicle from at least one imaging device (2a to 2d) installed in the vehicle. The first generation section is configured to generate a first converted image that is an image as seen from a first viewpoint in an interior of the vehicle, based on the captured image at a latest imaging time point. The calculation section is configured to calculate displacement of the vehicle. The second generation section is configured to generate a second converted image that is an image as seen from the first viewpoint at the latest imaging time point and is an image of an area including under the vehicle, based on the captured image captured earlier than the latest imaging time point and the displacement. The display processing section is configured to cause a display device visible to an occupant of the vehicle to display a display image obtained by compositing the first converted image and the second converted image.

According to this configuration, the image seen from the first viewpoint can be composited with the image of the area including under the vehicle generated by the second generation section using past images (that is, history images) to generate a display image that is an image of surroundings of the vehicle including under the vehicle. Therefore, it is possible to generally comprehend the situation under the vehicle.

What is claimed is:

1. A display processing device installed in a vehicle, the device comprising:
an acquisition section configured to acquire a captured image of surroundings of the vehicle from at least one imaging device installed in the vehicle;
a first generation section configured to generate a first converted image that is an image as seen from a first viewpoint in an interior of the vehicle, based on the captured image at a latest imaging time point;
a calculation section configured to calculate displacement of the vehicle;
a second generation section configured to generate a second converted image that is an image as seen from the first viewpoint at the latest imaging time point and is an image of an area including under the vehicle, based on the captured image captured earlier than the latest imaging time point and the displacement; and
a display processing section configured to cause a display device visible to an occupant of the vehicle to display a display image obtained by compositing the first converted image and the second converted image.

2. The display processing device according to claim 1, wherein
the second generation section includes:
a first conversion section configured to convert the captured image into a top view image as seen from a second viewpoint above the vehicle;
a composition section configured to generate a history composite image by compositing a plurality of the top view images different in imaging time point; and
a second conversion section configured to convert the history composite image into an image as seen from the first viewpoint to generate the second converted image.

3. The display processing device according to claim 1, wherein
the display processing section causes the display device to display the display image with which a predetermined background image is composited, instead of the second converted image, until generation of the second converted image that fills an entire region of the display image not filled with the first converted image.

4. The display processing device according to claim 1, wherein
the display processing section causes the display device to display the display image with which a predetermined background image is composited, instead of the second converted image until generation of the second converted image that fills at least part of a region of the display image not filled with the first converted image, and when the second converted image is generated, the display processing section causes the display device to display the display image with which the second converted image is composited, instead of the at least part of the predetermined background image.

5. The display processing device according to claim 1, wherein
the display processing section is configured to cause the display device to display the display image in a mode in which the first converted image and the second converted image are identifiable.

6. The display processing device according to claim 5, wherein the display processing section is configured to cause the display device to display the display image in which brightness of the second converted image is lowered.
